(19) United States
(12) Patent Application Publication
(10) Pub. No.: US 2015/0058101 A1
(43) Pub. Date: Feb. 26, 2015

(54) MANAGING PERSONAL PARKING SPACE

(71) Applicant: KT CORPORATION, Gyeonggi-do (KR)

(72) Inventor: Sang-Bong HAN, Gyeonggi-do (KR)

(73) Assignee: KT CORPORATION

(21) Appl. No.: 14/468,578

(22) Filed: Aug. 26, 2014

(30) Foreign Application Priority Data
Aug. 26, 2013 (KR) 10-2013-0101331

(51) Int. Cl. G07B 15/02

(52) U.S. Cl. CPC G07B 15/02
USPC 705/13

(57) ABSTRACT

The disclosure is related to renting a parking space to others. In order to renting a parking space to others, a service server monitors a target parking space through associated monitoring devices. Based on the monitoring information, the service server detects a vehicle for renting the target parking space. The service server performs a parking space renting operation in connection with user equipment user equipment associated with a parking space owner and a parking space requester.

### CROSS REFERENCE TO PRIOR APPLICATIONS

The present application claims priority under 35 U.S.C. §119 to Korean Patent Application No. 10-2013-0101331 (filed on Aug. 26, 2013), which is hereby incorporated by reference in its entirety.

### BACKGROUND

The present disclosure relates to renting personal parking spaces. One of disadvantages of living in a city is lack of public parking spaces. In order to overcome such problem, a personal parking space might be used. Such a personal parking space becomes vacant when an owner leaves home or office. Accordingly, the owner of the parking space might want to rent the personal parking space for a desired time period.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a parking space renting service may be provided through a communication network.

In accordance with another aspect of the present invention, a personal parking space may be monitored and managed for enabling a parking space owner to rent a personal parking space to others.

In accordance with at least one embodiment a method may be provided for renting a parking space with others. The method may include monitoring a target parking space through controlling monitoring devices installed around a target parking space based on target parking space information, detecting a vehicle in the target parking space based on the monitoring result, and performing a first parking space renting operation for renting the target parking space to the detected vehicle through user equipment associated with the detected vehicle.

The monitoring may include determining the target parking space based on the target parking space information included in registration information of a parking space owner of the target parking space, controlling at least one monitoring device installed around the target parking space to monitor the target parking space, and receiving the monitoring information from the at least one monitoring device.

The monitoring devices may include a sensor configured to detect an object located in the target parking space, a signal detector configured to detect a signal transmitted from a vehicle, and an image capturing device configured to capture images of the target parking space.

The detecting may include analyzing signals detected by and images of the target parking space captured by at least one of monitoring devices and determining whether a vehicle is located in the target parking space based on the analysis result.

The first parking space renting operation may include transmitting an inquiry message to user equipment associated with the detected vehicle for asking whether to rent the target parking space, determining whether the detected vehicle wants to rent the target parking space at an associated rental condition based on a response message received in response to the inquiry message, performing an accounting procedure for charging a rental fee of the target parking space to the detected vehicle when the detected vehicle wants to rent the target parking space, updating the target parking space information based on the associated rental condition including a rental period, and monitoring the target parking space based on the updated target parking space information.

The first parking space renting operation may include transmitting a request message to user equipment associated with the detected vehicle for asking to leave the target parking and transmitting a towing request message to an associated towing station to tow the detected vehicle from the target parking space when the detected vehicle is detected again in the target parking space after transmitting the request message.

The performing a first parking space renting operation may include determining whether a detected vehicle is an authorized vehicle based on registration information of a parking space owner upon detection of a vehicle, performing the first parking space renting operation when the detected vehicle is an unauthorized vehicle, otherwise, monitoring the target parking space without performing the parking space renting operation.

The performing a first parking space renting operation may include determining whether a detection time is in a scheduled time for renting the target parking space when a vehicle is detected in the target parking space, performing the first parking space renting operation when the detection time is in the scheduled time, otherwise, performing a second parking space renting operation. The scheduled time is a desired time for renting a target parking space, which is set by an associated parking space owner.

The second parking space renting operation may include transmitting an inquiry message to user equipment of the associated parking space owner whether to rent the target parking space to the detected vehicle when the detection time is not in the scheduled time, determining whether the associated parking space owner wants to rent the target parking space by a response message received in response to the inquiry message, and performing the first parking space renting operation when the associated parking space owner wants to rent the target parking space.

The second parking space renting operation may include transmitting a request message to user equipment associated with the detected vehicle for asking to leave the target parking space and transmitting a towing request message to an associated towing station to tow the detected vehicle from the target parking space when the detected vehicle is detected again in the target parking space after transmitting the request message.

The method may further include monitoring the target parking space after performing the first parking space renting operation based on target parking space information updated based on the first parking space renting operation, transmitting an inquiry message to user equipment associated with the detected vehicle for asking whether to extend a rental period, performing an accounting procedure for charging an extension fee of the target parking space to the detected vehicle when the detected vehicle wants to extend the rental period of the target parking space, updating the target parking space information based on the extended rental period, and monitoring the target parking space based on the updated target parking space information.

The method may further include transmitting a request message to user equipment associated with the detected vehicle for asking to leave the target parking when the detected vehicle request no extension of the rental period and transmitting a towing request message to an associated towing station to tow the detected vehicle from the target parking space when the detected vehicle is detected again in the target parking space after transmitting the request message.

The method may further include receiving a registration request from a parking space owner, obtaining target parking space information, owner information, and desired rental condition information from the parking space owner, storing and managing the target parking space information, the owner information, and the desired rental condition information as the registration information of the associated parking space owner, and monitoring the target parking space of the associated parking space owner based on the stored registration information of the associated parking space owner.

The method may further include receiving a registration request from a parking space requester, obtaining vehicle information and driving information of the parking space requester, and storing and managing the vehicle information and the driving information in connection with the associated parking space requester.

In accordance with at least one embodiment, a method may be provided for renting a parking space with others. The method may include providing an available parking space list to user equipment associated with a parking space requester in response to a request from the parking space requester, receiving a parking space renting request with a selected parking space from the parking space requester through the associated user equipment, and performing a parking space renting operation for renting the selected parking space to the parking space requester.

The method may further include receiving a reservation request with a selected parking space and a desired rental time from the parking space requester, performing a reservation operation of the selected parking space based on the desired rental time as a reserved rental time, updating target parking space information of the selected parking space based on the result of the reservation operation, and monitoring the selected parking space based on the updated target parking space information.

The method may further include transmitting an inquiry message to user equipment associated with the parking space requester at a predetermined time before the reserved rental time for asking whether to keep the reservation of the selected parking space, updating the target parking space information of the selected parking space based on a response message received in response to the inquiry message, and monitoring the target parking space based on the updated target parking space information.

The transmitting the inquiry message may include determining a location of the parking space requester at a predetermined time before the reserved rental time, estimating an arrival time of the parking space requester at the selected parking space, and transmitting the inquiry message when the estimated arrival time is later than the reserved rental time.

The receiving a reservation request may include determining whether more than two reservation request messages are received for reserving a first parking space with a same desired rental period from parking space requesters, performing an auction procedure for selecting one of the parking space requesters to rent the first parking space, otherwise, performing a reservation operation of the selected parking space based on the desired rental time as a reserved rental time.

The performing an auction procedure may include receiving an auction condition from an associated parking space owner, selecting one offering a higher bid from the parking space requesters by performing the auction procedure based on the received auction condition, and performing the parking space renting procedure to rent the target parking space to the selected one.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a service for renting a parking space in accordance with at least one embodiment;

FIG. 2 illustrates a service server for providing a parking space renting service in connection with user equipment associated with a parking space owner and a parking space requester in accordance with at least one embodiment;

FIG. 3 illustrates registering a parking space owner and a parking space requester for a parking space renting service and monitoring a target parking space in accordance with at least one embodiment;

FIG. 4 illustrates renting a vacant parking space in a reserved time for an authorized vehicle in accordance with at least one embodiment;

FIG. 5 illustrates a parking space renting operation for a scheduled time in accordance with at least one embodiment;

FIG. 6 illustrates requesting an available parking space list in accordance with at least one embodiment;

FIG. 7 illustrates an auction procedure performed when more than two parking space requesters want one same parking space in accordance with at least one embodiment; and

FIG. 8 illustrates renting a parking space based on reservation in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

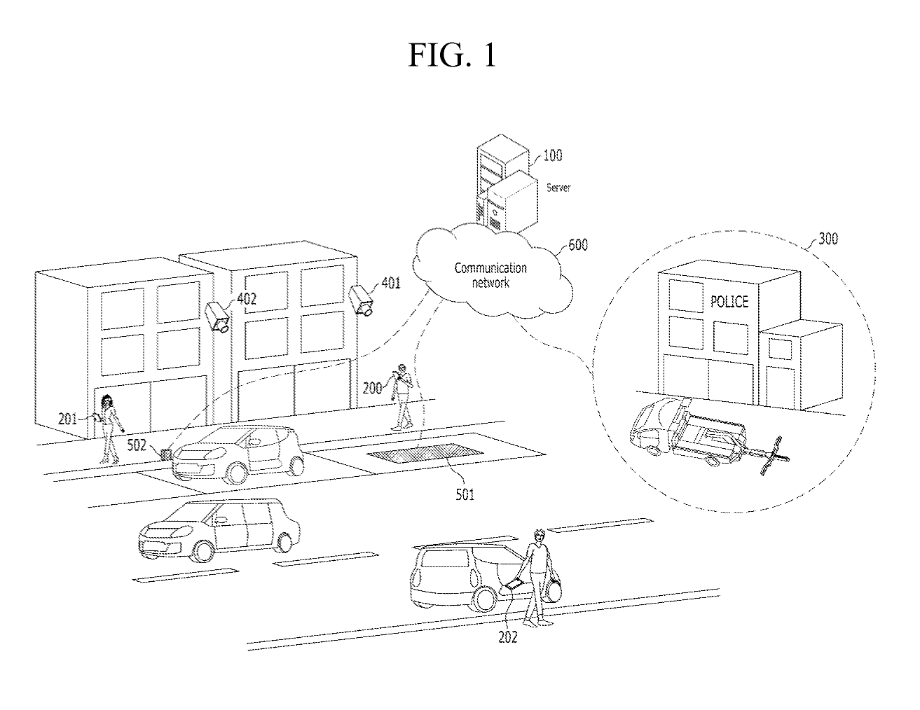

In accordance with at least one embodiment, a service server may monitor and manage a personal parking space through a plurality of monitoring devices deployed around the personal parking space and enable a parking space owner to rent the parking space to others through user equipment associated with the parking space owner and a parking space requester. Hereinafter, such a parking space renting service will be described with reference to FIG. 1. For convenience and ease of understanding, operations of a service server and associated user equipment will be described as providing the parking space renting service, but the present invention is not limited thereto. Such operations may be applied for a parking space sharing service.

FIG. 1 illustrates a service for renting a parking space in accordance with at least one embodiment.

Referring to FIG. 1, a parking space renting service may enable a parking space owner to rent a private parking space for a predetermined scheduled time period in accordance with at least one embodiment. The parking space renting service may be provided through service server 100. In order to provide such a service, service server 100 may collect information on a target parking space through a plurality of monitoring devices and monitor the target parking space based on the collected information. For example, service server 100 may be coupled to image capturing devices 401 and 402 and signal readers 501 and 502, as the monitoring devices, through communication network 600. Based on the collected information, service server 100 may manage a target parking space in response to a request of an associated parking space owner. For example, service server 100 may prevent the vacant parking space from being occupied by an unauthorized vehicle and rent the vacant parking space to an authorized vehicle.

In accordance with at least one embodiment, such a parking space renting service may be provided through communication between service server 100, user equipment 201 associated with a parking space owner, and user equipment 202 associated with a parking space requester. For example, service server 100 may manage a target parking space of a parking space owner through controlling a plurality of monitoring devices 401, 402, 501, and 502 and exchange messages, as managing results, with user equipment 201 and 202. Furthermore, service server 100 may receive instructions and information from the parking space owner and the parking space requester through user equipment 201 and 202.

User equipment 201 and 202 may be an electronic device capable of communication, processing data, storing information, receiving information from a user, and outputting information to a user. For example, user equipment 201 and 202 may include a smart phone, a mobile terminal, a pad-like device, a personal data assistance (PDA), a laptop computer, a personal computer, and so forth. Furthermore, user equipment 201 and 202 may be an electronic device mounted on a vehicle, such as a navigation system and an entertainment system.

As described, service server 100 may be coupled to a plurality of monitoring devices 401, 402, 501, and 502 through communication network 600 and collect monitoring information from monitoring devices 401, 402, 501, and 502, as a result of monitoring a target parking space. Monitoring devices 401, 402, 501, and 502 may be installed or deployed around a target parking space to monitor a target parking space in response to control of service server 100. As the monitoring result, monitoring devices 401, 402, 501, and 502 transmit the monitoring information to service server 100 through communication network 600 at regular interval, in real-time, or in response to a message from service server 100.

Such monitoring devices may include signal readers 501 and 502 and image capturing devices 401 and 402. Signal readers 501 and 502 may be a radio frequency identification (RFID) reader for reading a RF signal from a RFID tag, but the present invention is not limited thereto. For example, when a vehicle is parked at a target parking space, RFID readers 501 and 502 may receive a RF signal from a RFID tag attached at the vehicle and transmit the detected RFID signal to service server 100. Such RFID signal may include vehicle information (e.g., license plate number) and driver information (e.g., contact information and a target device to contact).

Image capturing devices 401 and 402 may include closed circuit TV (CCTV) camera or a Web-camera, but the present invention is not limited thereto. For example, image capturing devices 401 and 402 may capture images of a target parking space and transmit the captured images to service server 100 at regular interval, in real-time, or in response to the control of service server 100. Furthermore, monitoring devices may include various types of sensors that detect an object or movement in a target parking space.

Based on the monitoring information (e.g., RFID signal and captured images) collected from monitoring devices 401, 402, 501, and 502, service server 100 monitors a target parking space and provides a parking space renting service to a parking space owner and a parking space requester. In order to provide the parking space renting service, service 100 may perform operations as follows.

Service server 100 may analyze the collected monitoring information from the monitoring devices and detect a vehicle located at a target parking space based on the collected monitoring information. For example, when a vehicle enters a target parking space and stays in the target parking space for a predetermined time, RFID reader 502 may receive a RFID signal from a tag installed in the vehicle and transmit the received RFID signal to service server 100. In addition, image capturing device 402 may capture an image of the target parking space with the vehicle parked and transmit the captured image to service server 100. Service server 100 may analyze such received RFID signal and captured images and detect the vehicle parked in the target parking space based on the analysis result.

Upon the detection of the vehicle, service server 100 may determine whether the detected vehicle is an authorized vehicle to use the target parking space based on the monitoring information. When the detected vehicle is not the authorized vehicle, service sever 100 may ask a driver of the detected vehicle to rent the parking space or request to leave the target parking space through user equipment associated with a driver of the detected vehicle. When the driver of the detected vehicle wants to rent the target parking space, service server 100 may perform a parking space renting procedure in connection with user equipment associated with the driver of the detected vehicle and the parking space owner. Such operation will be described in more detail with reference to FIG. 3 to FIG. 5.

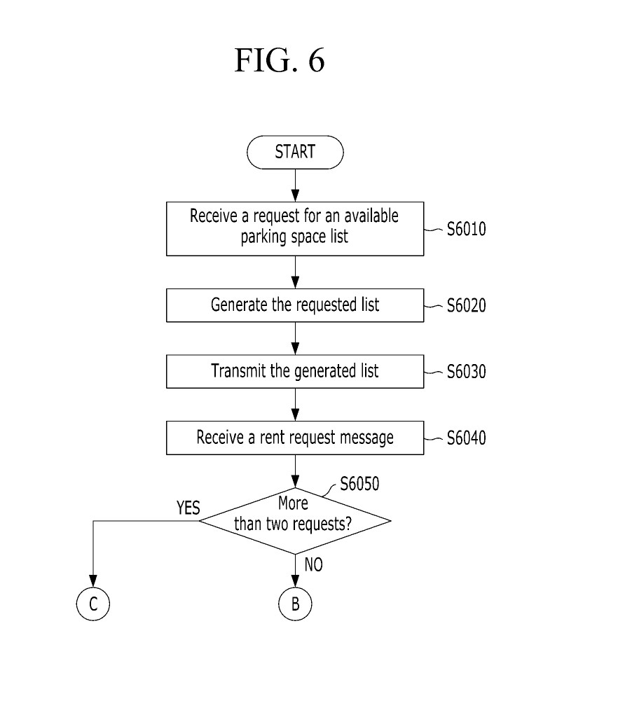

Furthermore, service server 100 may receive a request message for available parking spaces near a predetermined location from a parking space requester in accordance with at least one embodiment. In response to the request message, service server 100 may generate the available parking space list and transmit the generated available parking space list to user equipment associated with the parking space requester. Such operation will be described in detail with reference to FIG. 6.

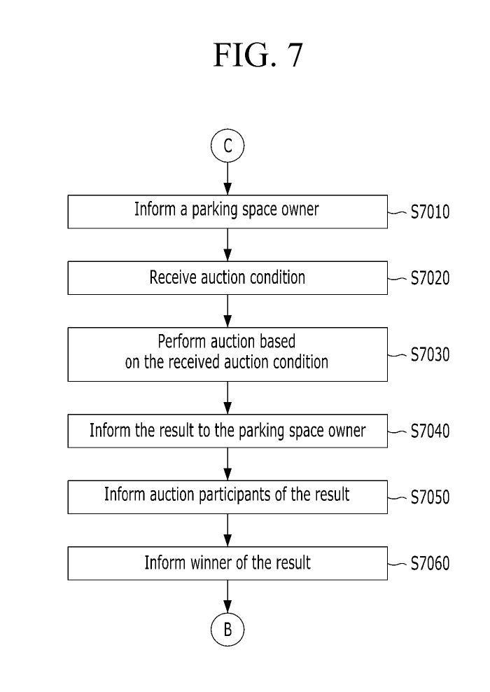

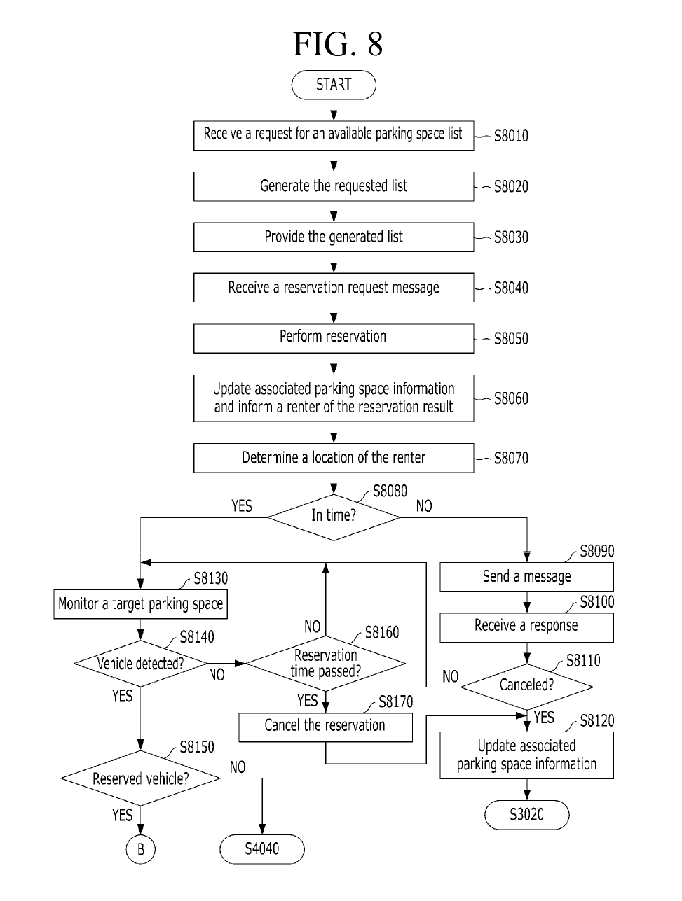

When service server 100 receives more than two request messages for one parking space at the same time, service server 100 may perform an auction procedure with auction conditions determined by a parking space owner. Such operation will be described in detail with reference to FIG. 7. In addition, service server 100 may receive a request message for reserving at least one parking space from a parking space requester and perform a parking space reservation procedure based on information included in the request message. Such operation will be described in detail with reference to FIG. 8.

As described, service server 100 may perform various operations for managing a target parking space. For example, service server 100 may request a driver of a detected vehicle to leave a target parking space when the detected vehicle is not an authorized vehicle and when a driver of the detected vehicle does not want to rent the target parking space. As shown in FIG. 1, service server 100 may be coupled to towing station 300 (e.g., towing company, police station, or towing truck) through communication network 600. When the detected vehicle stays at the target parking space after the request to leave, service server 100 may transmit a message to towing station 300 to tow the detected vehicle from the target parking space. Towing station 300 may be a device mounted on a tow truck.

In accordance with at least one embodiment, the parking space monitoring and renting operation may be performed through communication between service server 100 and user equipment 201 and 202 associated with the parking space owner and the parking space requester. For example, service server 100 may store software program (e.g., application or App) dedicated for monitoring and renting a target parking space and provide the detected software program to user equipment 201 and 202. User equipment 201 and 202 may download the software program from service server 100 and installs the downloaded software program for monitoring and renting a target parking space. When the installed program is executed in response to a predetermined user input, user equipment 201 and 202 may produce and display a graphic user interface for enabling a user to perform various tasks such as inputting information and/or instruction, requesting service server 100 to rent a target parking space, requesting towing station 300 to tow an unauthorized vehicle, and so forth. Such operation will be described in detail with reference to FIG. 3 to FIG. 8.

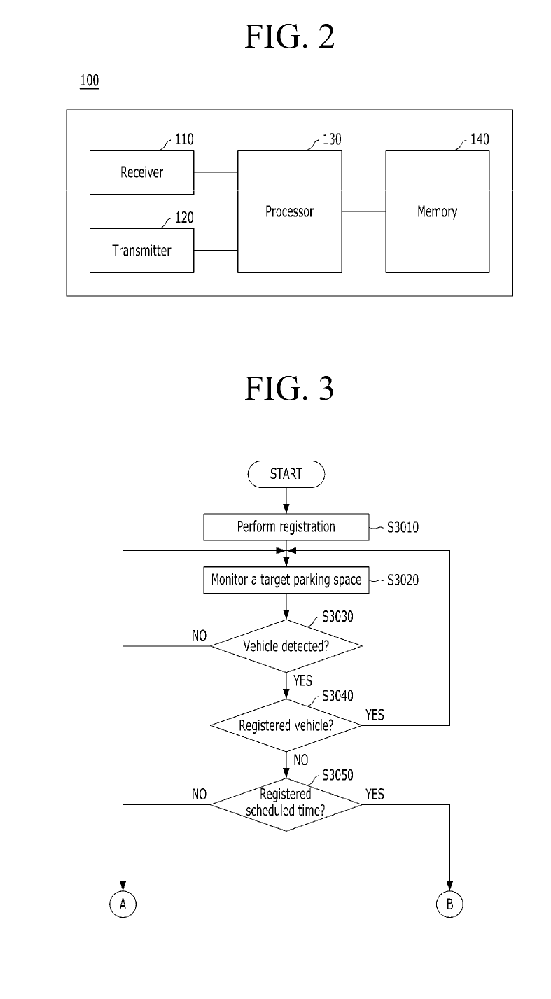

As described, service server 100 is coupled to user equipment 201 and 202 through communication network 600 and performs various operations for monitoring and renting a target parking space. Such service server 100 may be a computing system of a service provider, but the present invention is not limited thereto. Hereinafter, service server 100 will be described with reference to FIG. 2.

FIG. 2 illustrates a service server for providing a parking space renting service in connection with user equipment associated with a parking space owner and a parking space requester in accordance with at least one embodiment.

Referring to FIG. 2, service server 100 may include receiver 110, transmitter 120, processor 130, and memory 140. Service server 100 is illustrated as including four constituent elements in FIG. 2, but the present invention is not limited thereto.

Receiver 110 may be a device capable of receiving various types of signals from other entities coupled through communication network 600. Receiver 110 may be a part of a communication device for communication with other entities. For example, receiver 110 may receive various types of information, messages, and instructions from user equipment 201 and 202 through communication network 600. Furthermore, receiver 110 may receive various type of monitoring information, such as RFID signal and captured images, from monitoring devices 401, 402, 501, and 502. Receiver 110 may deliver the received information or signal to processor 130.

Transmitter 120 may be another part of the communication device in service server 100. Transmitter 120 may be a device capable of transmitting various types of signals to other entities coupled through communication network 600. For example, transmitter 120 may transmit various types of information, messages, and instructions, generated by processor 130, to user equipment 201 and 202 through communication network 600. Furthermore, transmitter 120 may transmit control signals, generated by processor 130, to monitoring devices 401, 402, 501, and 502 through communication network 600.

Receiver 110 and transmitter 120 may include at least one module for communicating with other party through communication network 600. For example, receiver 110 and transmitter 120 may include any or all of a broadcasting signal receiving module, a mobile communication module, a wireless internet module, a short-distance communication module, and a location information module (e.g., GPS receiving module). The short-distance communication module may include a Bluetooth circuit, a radio frequency identification (RFID) circuit, an infrared data association (IrDA) circuit, an ultra-wideband (UWB) circuit, a Zigbee circuit, and a near field communication (NFC) module circuit.

In order to provide a parking space renting service, receiver 110 may receive various messages from user equipment 201 and 202 associated with a parking space owner and a parking space requester. For example, receiver 110 may receive a registration request message and registration information from user equipments associated with a parking space owner and a parking space requester. Such a registration request message from a parking space owner my include parking space information, owner information, and desired renting conditions. Parking space information may include a location of a target parking space, a size of a target parking space (e.g., a width or a height, for a small-sized car, a middle-sized car, a SUV, so forth), identification, and surrounding information such as shops, residential area, school zone, and so forth. The owner information may include identification of the parking space owner, contact information of the parking space owner, device information on user equipment 200 of the parking space owner, information on vehicles authorized by the parking space owner. The desired renting conditions may include a scheduled time for renting, a renting rate, and so forth.

The registration request message from a parking space requester may include vehicle information and driver information. Vehicle information may include vehicle identification (e.g., license plate number) and driver information may include device information (e.g., a device to communication) and contact information (e.g., user equipment, mobile terminal, and so forth).

Receiver 110 may receive a response message from a parking space owner in response to an inquiry message asking whether to rent a target parking space to a detected vehicle in an unscheduled time (e.g., reserved time for an authorized vehicle only). Furthermore, receiver 110 may receive a response message from a vehicle owner in response to an inquiry message asking whether to rent a target parking space from a parking space owner and in response to an inquiry message asking whether to extend a rental period. In addition, receiver 110 may receive messages related to auction and reservation.

Transmitter 120 may transmit an inquiry message to a registered parking space owner whether to rent a target parking space in a reserved time for authorized vehicle only (e.g., unscheduled time for renting). Such an inquiry message may include information on a detected vehicle and a detection time. Furthermore, transmitter 120 may transmit a towing request message to towing station 300 for asking towing a vehicle in a target parking space and transmit a warning message to a driver of the detected vehicle. In addition, transmitter 120 may transmit various messages related to auction and reservation.

Processor 130 may control overall operation of the constituent elements of service server 100. Particularly, processor 130 may perform operations necessary for driving the constituent elements of service server 100 for providing a parking space renting service.

For example, processor 130 may perform a registration procedure for registering a parking space owner and a parking space requester at service sever 100 to use a parking space renting service in accordance with at least one embodiment. Processor 130 may perform a monitoring operation including collecting monitoring information from monitoring devices and extracting vehicle information and driver information from the collected monitoring information. Such operation will be described in detail with reference to FIG. 3.

For example, processor 130 may extract vehicle information from the target parking space monitoring information collected from monitoring devices 401, 402, 501, and 502. Upon the receipt of the RF signal from signal reader 501 through receiver 110, processor 130 may extract vehicle and driver information from the received RF signal. The RF signal may be transmitted at a regular interval, but the present invention is not limited thereto. The RF signal may include information indicating whether a target parking space is occupied or not. When the target parking space is occupied by a vehicle having a tag (e.g., RFID tag), a RFID signal may further include vehicle information and driver information, such as an owner of the vehicle, a license plate number, a device to communication, and a contact number. When the target parking space is occupied by a vehicle not having a RFID tag, processor 130 may collect images captured from image capturing devices 401 and 402 and extract vehicle and driver information from the collected images.

For convenience and ease of understanding, the parking space owner may be referred to as an owner of a private parking space. A vehicle of the parking space owner may have the highest priority to use a target parking space (e.g., authorized vehicle). The parking space owner may register at service server 100 for the parking space renting service in order to share or to rent the parking space to the others. The parking space requester may be referred to as a person registered for the parking space renting service in order to temporally use a parking space based on authorization of the parking space owner.

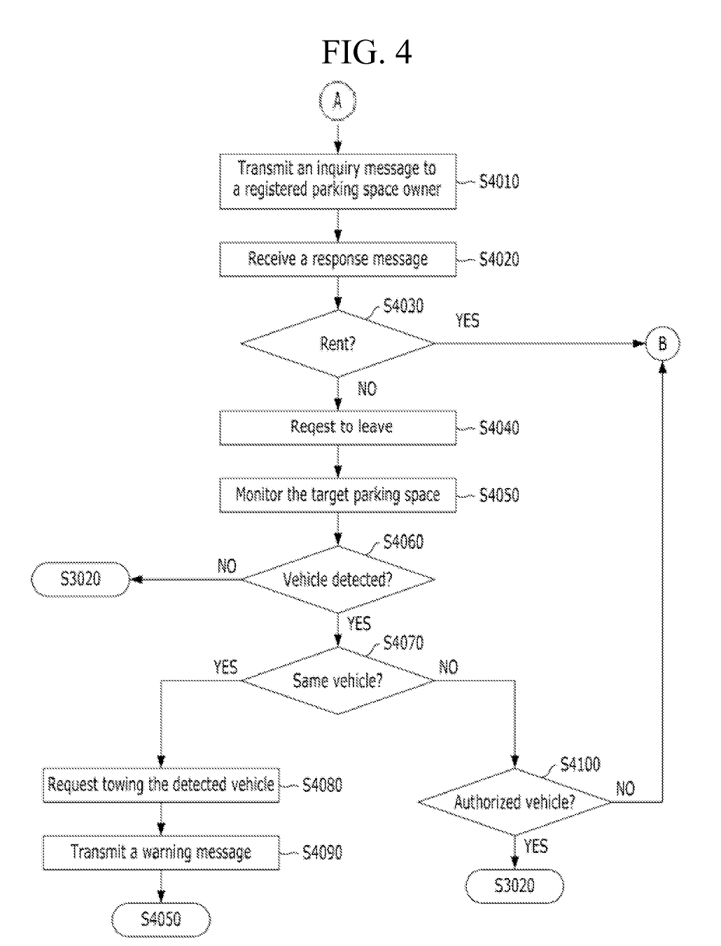

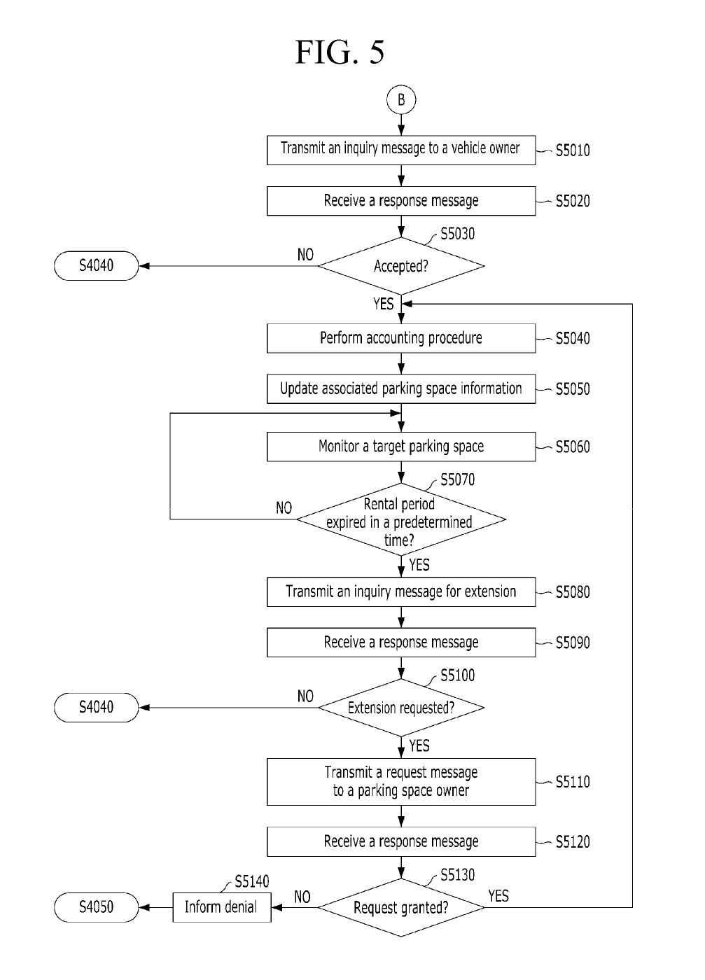

Processor 130 may determine whether a detection time of a vehicle is in a scheduled time period for renting the target parking space based on information stored in memory 140 and perform one of a parking space renting operation (B) for a scheduled time and a parking space renting operation (A) for an unscheduled time (e.g., reserved time for authorized vehicle). Such operation will be described in detail with reference to FIG. 4 and FIG. 5.

Processor 130 may perform operation for providing an available parking space list to a parking space requester and perform auction when more than two request messages are for one same parking space simultaneously. Such operation will be described in detail with reference to FIG. 6 and FIG. 7. Furthermore, processor 130 may preform operations for parking space reservation. Such operation will be described in detail with reference to FIG. 8. In addition, processor 130 may perform a rental term extension operation and a towing requesting operation.

Memory 140 may be used as a data storage device of user equipment 100. Memory 140 may store information necessary for operating service server 100 and performing certain operations for a parking space renting service. Such information may include any software programs and related data. Memory 120 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto.

Memory 140 may store information obtained from a parking space owner and a parking space requester during registration. For example, memory 130 may store parking space information, owner information, and desired renting conditions of a parking space owner and vehicle information and driver information of a parking space requester. In addition, memory 140 may update and store parking space information whenever states of parking spaces are changed.

As described, service server 100 provides a parking space renting service or a parking space sharing service to a parking space owner and a parking space requester. In order to provide such a service, service server 100 may perform registration, extraction, monitoring, renting, sharing, auction, reservation, and so forth. Hereinafter, such operation for providing a parking space renting service will be described in detail with reference to FIG. 3 to FIG. 8. For convenience and ease of understanding, operations will be described as renting a parking space to others, but the present invention is not limited thereto. Such operations may be applied similarly for sharing a parking space to others.

FIG. 3 illustrates registering a parking space owner and a parking space requester for a parking space renting service and monitoring a target parking space in accordance with at least one embodiment. For convenience and ease of understanding, a monitoring operation for monitoring an unoccupied parking space (e.g., a vacant parking space) will be described with reference to FIG. 3, but the present invention is not limited thereto.

Referring to FIG. 3, a registration procedure may be performed in response to a request from a parking space owner or a parking space requester at step S3010. For example, when a parking space owner wants to rent a parking space, the parking space owner may register at service server 100 for the service. Furthermore, when a parking space requester wants to rent one of parking spaces, the parking space requester may register at service server 100 for the service. Such registration may be performed through a web-site of service server 100 or software program (e.g., application or App) downloaded from service server 100 to user equipment 200 of the parking space owner or the parking space requester and installed at user equipment 200.

Through the registration procedure, the parking space owner provides information on a target parking space to rent or to share with renting conditions to service server 100. Particularly, service server 100 may request the parking space owner to enter information on a target parking space to rent, owner information, and desired renting conditions through an associated web-page posted on the Internet or an associated app installed in user equipment 200 of the parking space owner. In response to the request, the parking space owner provides parking space information and desired renting conditions to service server 100. Parking space information may include a location of a target parking space, a size of a target parking space (e.g., a width or a height, for a small-sized car, a middle-sized car, a SUV, so forth), identification, and surrounding information such as shops, residential area, school zone, and so forth. The owner information may include identification of the parking space owner, contact information of the parking space owner, device information on user equipment 200 of the parking space owner, and information on vehicles authorized by the parking space owner. The desired renting conditions may include a scheduled time for renting, a renting rate, and so forth.

Particularly, the registration procedure may be performed as follows. User equipment 200 may initiate a registration procedure of service server 100 through a designated application, downloaded from service server 100 and installed in user equipment 200. Service server 100 may request user equipment 200 to provide parking space information, owner information, and desired renting conditions. User equipment 200 may request the parking space owner to enter or to choose parking space information, owner information, and desired renting condition through a graphic user interface produced and display on user equipment 200 as a result of executing the designated application. User equipment 200 may obtain the requested information from the parking space owner through the graphic user interface and provide the obtained information to service server 100. Service server 100 may store and manage the received information including the parking space information, the owner information, and the desired rent conditions.

Through the registration procedure, the parking space requester provides vehicle information on a vehicle and driver information on an owner (e.g., driver) of the vehicle to service server 100. Particularly, service server 100 may request the parking space requester to enter information on a vehicle and an owner (e.g., main driver) through an associated web-page posted on the Internet or an associated app installed in user equipment 200 of the parking space owner. In response to the request, the parking space requester provides vehicle information and driver information to service server 100. Vehicle information may include vehicle identification (e.g., license plate number) and driver information may include device information (e.g., a device to communication) and contact information (e.g., user equipment, mobile terminal, and so forth). Service server 100 may store the information from the parking space requester, as member information, and use the stored information to transmit a message to a driver of a vehicle detected through monitoring devices.

At step S3020, a target parking space may be monitored. For example, service server 100 may determine a parking space to monitor based on the registered information, control a plurality of monitoring devices deployed around the target parking space to monitor the target parking space, and collect monitoring information from the monitoring devices, such as image capturing devices 401 and 402 or signal readers 501 and 502.

At step S3030, determination may be made so as whether any vehicle is detected at the target parking space. For example, service server 100 may analyze the collected monitoring information and determine whether a current state of the target parking space is changed or not. That is, service server 100 may determine whether a current state of the target parking space is changed from a vacant state to an occupied state based on the monitoring information. Such state change may be generated when a vehicle is tried to be parked or is parked in the target parking space.

When a vehicle is not detected (No—S3030), the target parking space is continuously monitored at step S3020. For example, when service server 100 detects no vehicle parked in the target parking space based on the analysis of the collected monitoring information, service server 100 continuously monitors the target parking space by controlling the associated monitoring devices.

When a vehicle is detected at the target parking space (Yes—S3030), determination may be made so as whether the detected vehicle is a registered vehicle at step S3040. For example, when service server 100 detects a vehicle parked in the target parking space based on the analysis of the collected monitoring information or when service server 100 may receive a state change signal from at least one monitoring devices, service server 100 determine whether the parked vehicle is an authorized vehicle registered for the target parking space. For example, the authorized vehicle may be any vehicle authorized to park at the target parking space by the parking space owner. The authorized vehicle may include the parking space owner's vehicle.

Such determination may be performed by analyzing images captured from at least one of image capturing devices 401 and 402 or by analyzing radio frequency (RF) signals obtained by at least one of RF identification (RFID) readers 501 and 502. Based on the result of analysis of the captured images, service server 200 may obtain a vehicle license plate number and/or a driver's contact number such as a mobile phone number. Furthermore, the obtained RFID signal may include vehicle information on vehicle and driver information on a driver of the vehicle, such as vehicle license plate number, a device to communicate, and/or a contact number of a designated device (e.g., driver's smart phone).

When the detected vehicle is the authorized vehicle (Yes—S3040), the target parking space is continuously monitored at step S3020. For example, when service server 100 determines that a vehicle parked in the target parking space is one of the authorized vehicles based on the analysis of the collected monitoring information and the stored registration information, service server 100 continuously monitor the target parking space by controlling the associated monitoring devices.

When the detected vehicle is not the authorized vehicle (No—S3040), determination may be made so as whether a time of detecting the vehicle is in a scheduled time for renting the target parking space at step S3050. The scheduled time denotes a time that the target parking space is not used by the authorized vehicles. Such a scheduled time may be set by the parking space owner during the registration or upon generation of a predetermined event, stored in service server 100, and managed by service server 100 with the registration information. For example, service server 100 obtains a scheduled time associated with the target parking space and compares the obtained schedule time and the detection time to determine whether the detection time is in the scheduled time.

When the detection time is in the scheduled time (Yes—S3050), a parking space renting operation (B) for the scheduled time may be performed. Such an operation (B) for the rent scheduled time will be described in detail with reference to FIG. 5.

When the detection time is not in the scheduled time (No—S3050), a parking space renting operation (A) for an unscheduled time may be performed. Hereinafter, the operation (A) for the scheduled time will be described in detail with reference to FIG. 4.

FIG. 4 illustrates renting a vacant parking space in a reserved time for an authorized vehicle in accordance with at least one embodiment.

Referring to FIG. 4, when an unauthorized vehicle is detected at the target parking space in a reserved time for an authorized vehicle, which is an unscheduled time for renting, an inquiry message may be transmitted to a registered parking space owner at step S4010. For example, when service server 100 detects an unauthorized vehicle trying to park or parking at the target parking space in the unscheduled time, service server 100 may transmit the inquiry message to user equipment 200 of the parking space owner in order to ask the parking space owner whether to rent the target parking space although a detected time is no a scheduled time for renting. Such an inquiry message may include information on a time period for renting the target parking space, a type of the detected vehicle, and a contact number of a driver of the detected vehicle.

At step S4020, a response message may be received in response to the inquiry message. For example, service server 100 receives the response message from user equipment 200 in response to the inquiry message. Such a response message may include information on whether the parking space owner wants to rent the target parking space or not in the unscheduled time, which is a reserved time for an authorized vehicle only. That is, the response message may include information whether the target parking space is allowed to be rented or not.

At step S4030, determination may be made so as whether the parking space owner wants to rent the target parking space. For example, service server 100 analyzes the response message received from user equipment 200 and determines whether the parking space owner wants to rent the target parking space.

When service server 100 determines that the parking space owner wants to rent the parking space (Yes—S4030), service server 100 may perform a parking space renting operation (B) for a schedule time for renting. Such operation will be described in detail with reference to FIG. 5.

When service server 100 determines that the parking space owner does not want to rent the parking space (No—S4030), the detected vehicle may be requested to leave the target parking space at step S4040. For example, service server 100 may transmit a warning message to user equipment of a driver of the detected vehicle based on information obtained from the captured images. The present invention, however, is not limited thereto. Service server 100 may control monitoring devices installed around the target parking space to warn the driver of the detected vehicle. For example, service server 100 may control a monitoring device to play a warning message in a voice through a speaker or control a monitoring device displaying a warning message through a dedicated display.

At step S4050, the target parking space may be continuously monitored. For example, after warned the detected vehicle, service server 100 continuously monitor the target parking space to control associated monitoring devices. At step S4060, determination may be made after a predetermined time whether a vehicle is detected at the target parking space. For example, service server 100 may determine whether a vehicle is detected at the target parking space within a predetermined time after sending the warning message to the detected vehicle.

When a vehicle is not detected (No—S4060), the target parking space may be continuously monitored at step S3020. When a vehicle is detected (Yes—S4060), determination may be made so as whether a currently detected vehicle is identical to the previously detected vehicle at step S4070. For example, service server 100 analyzes the information collected from the monitoring devices and determines whether the currently detected vehicle is same vehicle detected previously.

When the currently detected vehicle is identical to the previously detected vehicle (Yes—S4070), a towing request message may be transmitted to an associated towing station to tow the detected vehicle at step S4080. For example, service server 100 may generate and transmit a towing request message to towing station 300 to request towing the detected vehicle from the target parking space.

At step S4090, a warning message may be transmitted to the driver of the detected vehicle. For example, service server 100 transmits the warning message to the detected vehicle to leave the target parking space and inform the detected vehicle of the transmission of the towing request message.

When the currently detected vehicle is not identical to the previously detected vehicle (No—0S400), determination may be made so as whether the currently detected vehicle is an authorized vehicle at step S4100. When the currently detected vehicle is an authorized vehicle (Yes—S4100), the target parking space may be continuously monitored at step S3020. When the currently detected vehicle is not an authorized vehicle (No—S4100), service server 100 may perform a parking space renting operation (B) for a schedule time for renting. Hereinafter, such operation will be described in detail with reference to FIG. 5.

FIG. 5 illustrates a parking space renting operation for a scheduled time in accordance with at least one embodiment.

Referring to FIG. 5, when service server 100 detects a vehicle trying to park or parking at the target parking space during a scheduled time for renting a target parking space, an inquiry message may be transmitted to the detected vehicle at step S5010. As described, service server 100 detects a vehicle in the target parking space based on monitoring information collected from monitoring devices. If the detection time is in the schedule time for renting a target parking space, set by the parking space owner, service server 100 may ask a driver of the detected vehicle to rent the target parking space through transmitting the inquiry message. The inquiry message may include information on renting conditions such as an available rental term, a rental rate, and so forth.

Such an inquiry message may be transmitted to the driver through various methods. For example, the inquiry message may be transmitted to user equipment (e.g., a mobile phone, a smart phone, a pad-like device, or a laptop computer) of the driver, but the present invention is not limited thereto. The inquiry message may be transmitted to a device mounted on the detected vehicle, such as a navigation system or an entertainment system, or directed to the vehicle.

Such information on a target device to transmit the inquiry message and contact information thereof may be obtained through various methods. For example, based on the monitoring information, service server 100 may obtain information on the detected vehicle and a driver of the detected vehicle. A contact number of the driver may be posted on a windshield of the detected vehicle. Such a contact number may be a telephone number of a smart phone of the driver. Furthermore, such a contact number may be obtained through analyzing images captured by one of monitoring devices 401 and 402, but the present invention is not limited thereto.

Particularly, service server 100 may extract vehicle information and driver information from images captured by image capturing devices 401 and 402 installed or deployed around the target parking space. Service server 100 may extract the same from a RFID signal received from RFID reader 501 installed at the target parking space. Furthermore, service server 100 may extract vehicle identification from the collected monitoring information and obtain associated driver information from registration information stored in a memory of service server 100. Such driver information may include contact information of the driver, such as a telephone number of a mobile terminal of the driver. Based on such obtained information, service server 100 determines a target device to transmit an inquiry message and transmits an inquiry message to the determined target device, such as user equipment 200, associated with the detected vehicle.

The inquiry message was described as being transmitted from service server 100 to the driver of the detected vehicle, but the present invention is not limited thereto. That is, a request message for renting a target parking space may be transmitted from the detected vehicle to service server 100 when the detected vehicle is parking at the target parking space. For example, a code pattern image having information on service server 100 and the target parking space may be posted around the target parking space. The driver of the detected vehicle may scan the posted code pattern image using user equipment 201 and transmit the request message for renting the target parking space to service server 100 based on the information of the scanned code pattern image.

At step S5020, a response message may be received in response to the inquiry message from the detected vehicle. For example, service server 100 may receive the response message from the user equipment associated with the detected vehicle in response to the inquiry message. Such a response message may include information indicating whether the driver of the detected vehicle wants to rent the target parking space.

At step S5030, service server 100 may determine whether the driver of the detected vehicle wants to rent the target parking space and accepts the rental conditions of the parking space owner based on the information in the received response message.

When the driver of the detected vehicle does not want to rent the target parking space or when the driver of the detected vehicle disagrees with the rental condition (No—S5030), the detected vehicle may be requested to leave the target parking space at step S4040 in FIG. 4.

When the driver of the detected vehicle wants to rent the target parking space (Yes—S5030), an accounting procedure (e.g., a rental-fee charging procedure) for renting the target parking space may be performed at step S5040. For example, service server 100 may provide online charging information to user equipment 200 of the detected vehicle and perform the accounting procedure to receive a rental fee from the detected vehicle in connection with user equipment 200 and/or an associated accounting system.

At step S5050, service server 100 may update associated parking space information based on the rental conditions agreed by the detected vehicle, such as a rental period. That is, service server 100 may modify the associated parking space information as the target parking space occupied for the rental period and store the modified parking space information. At step S5060, service server 100 may monitor the target parking space based on the updated parking space information using at least one monitoring device.

At step S5070, service server 100 may determine whether the rental period of the detected vehicle is expired in a predetermined time, such as ten minutes before the rental period. When the rental period is not expired in the predetermined time (No—S5070), service server 100 may continuously monitor the target parking space at step S5060. When the rental period is expired in the predetermined time (Yes—S5070), service server 100 may transmit an inquiry message for extension of the rental period to user equipment 200 associated with the detected vehicle at step S5080.

At step S5090, service server 100 may receive a response message from user equipment 200 in response to the inquiry message. At step S5100, service server 100 may determine whether the rental period is requested to be extended based on the response message. When the rental period is not requested to be extended (No—S5100), service server 100 may transmit a warning message to the detected vehicle to leave the target parking space at step S4040 in FIG. 4.

When the rental period is requested to be extended (Yes—S5100), service server 100 may transmit a request message to user equipment associated with the parking space owner for extension of the rental period of the target parking space at step S5110. At step S5120, service server 100 may receive a response message from the user equipment associated with the parking space owner in response to the request message. At step S5130, service server 100 may determine whether the rental period extension request is granted based on the response message.

When the rental period extension request is not granted (No—S5130), service server 100 may inform the detected vehicle of the denial of the extension request at step S5140. Then, service server 100 may transmit a warning message to the detected vehicle and request the detected vehicle to leave the target parking space at step S4040 in FIG. 4.

When the rental period extension request is granted (Yes—S5130), service server 100 may perform an accounting procedure (e.g., extension fee charging procedure) for the rental period extension at step S5040. Then, service server 100 may update the associated parking space information based on the rental period extension at step S5050 and continuously monitor the target parking space based on the updated parking space information at step S5060.

As described, the operation of service server 100 for renting a parking space is initiated by detecting a vehicle in a target parking space, but the present invention is not limited thereto. Such operation may be initiated by a request of a parking space requester in accordance with at least one embodiment. For example, the parking space renting operation may be initiated by a request of an available parking space list, generated and transmitted by user equipment associated with the parking space requester. Such operation will be described in detail with reference to FIG. 6 and FIG. 7.

FIG. 6 illustrates requesting an available parking space list in accordance with at least one embodiment.

Referring to FIG. 6, service server 100 may receive a request message for an available parking space list from user equipment associated with a parking space requester at step S6010. Such a request message may include information on a location of the parking space requester (e.g., user equipment associated with the parking space requester).

At step S6020, service server 100 may generate a list of available parking spaces around the parking space requester based on the location information included in the request message. Such available parking spaces may be parking spaces registered for a parking space renting service, but the present invention is not limited thereto. At step S6030, service server 100 may transmit the generated list to the user equipment associated with the parking space requester. The available parking space list includes parking spaces located near to the location of the parking space requester, unoccupied by other vehicle, and having a scheduled time matched with a desired parking time of the parking space requester.

At step S6040, service serve 100 may receive a rent request message from the user equipment associated with the parking space requester. Based on the provided list, the parking space requester may select one of available parking spaces included in the provided list and transmit the selection information with the rent request message to service server 100 using the associated user equipment.

At step S6050, service server 100 determines whether more than two request messages are received for the one same parking space upon the receipt of the rent request message. When service server 100 receives one request message for one parking space (No—S6050), service server 100 may perform a parking space renting operation similar to the operation (B) described in FIG. 5.

When service server 100 receives more than two request messages for one parking space (Yes—S6050), service server 100 may perform an auction procedure as shown in FIG. 7. Hereinafter, such an auction procedure will be described in detail with reference to FIG. 7.

FIG. 7 illustrates an auction procedure performed when more than two parking space requesters want one same parking space in accordance with at least one embodiment.

Referring to FIG. 7, when more than two request messages are received for one same parking space, service server 100 may inform an associated parking space owner that more than two requests are received for the same parking space in the same rental period at step S7010. At step S7020, service server 100 may receive a response message including a desired auction condition from user equipment associated with the parking space owner. The desired auction condition may include information on an auction preference, such as a rental period or a rental fee, selected or determined by the parking space owner.

At step S7030, service server 100 may perform an auction based on the received auction condition from the parking space owner. For example, when the owner selects the rental fees as the auction preference, service sever 100 may perform the auction based on the rental fees. That is, a parking space requester offering a higher rental fee wins the auction. As another example, when the owner selects the rental term as the auction preference, service server 100 may perform the auction based on the rental term. That is, a parking space requester offering a longer rental fee wins the auction.

At step S7040, service server 100 may inform the result to the parking space owner after the auction. At step S7050, service server 100 may inform auction participants of the result, except the winner. At step S7060, service server 100 may inform the winner of the result. After informing, service server 100 may perform a parking space renting operation similar to the operation (B) illustrated in FIG. 5.

Service server 100 was illustrated as performing the auction procedure when more than two requests are received for one parking space, but the present invention is not limited thereto. For example, service server 100 may request a parking space owner to select one of parking space requesters. That is, service server 100 may provide information on each parking space requester, such as rental history of each parking space requester, to the parking space owner. Based on the provided information the parking space owner may directly select one of the parking space requester and request service server 100 to rent the target parking space to the selected parking space requester.

In addition, service server 100 may perform operations for reserving a parking space in accordance with at least one embodiment. Such an operation will be described with reference to FIG. 8.

FIG. 8 illustrates renting a parking space based on reservation in accordance with at least one embodiment.

Referring to FIG. 8, service sever 100 may receive a request message for an available parking space list from user equipment associated with a parking space requester at step S8010. The request message may include information on a desired location of a parking space and a desired rental date and time.

At step S8020, service server 100 may generate the list of available parking spaces based on information included in the request message. At step S8030, service server 100 may provide the generated list to the user equipment associated with the parking space requester.

At step S8040, service server 100 may receive a reservation request message from the user equipment associated with the parking space requester. The reservation request message may include a parking space selected by the parking space requester from the provided list.

At step S8050, service server 100 may perform a reservation procedure based on the information included in the received reservation request message. At step S8060, service server 100 may update associated parking space information of the selected parking space and inform the parking space requester of the reservation result. Based on the updated parking space information, service server 100 may monitor the selected parking space using associated monitoring devices.

At step S8070, service server 100 may detect a location of the reserved parking space requester at a predetermined time before the reserved rental period of the reserved parking space. At step S8080, service server 100 may determine whether the reserved parking space requester can be arrived at the target parking space on time based on the determined location of the reserved parking space requester.

When service server 100 determines that the reserved parking space requester cannot be arrived at the target parking space (No—S8080), service server 100 may transmit an inquiry message to ask whether the reserved parking space requester to cancel the reservation at step S8090. At step S8100, service server 100 may receive a response message in response to the inquiry message. At step S8110, service server 100 may determine whether the reservation is canceled based on the information included in the response message.

When the reservation is not canceled (No—S8110), service server 100 may continuously monitor the target parking space at step S8130. When the reservation is canceled (Yes—S8110), service server 100 may update associated parking space information at step S8120 and monitor the target parking space for other request a step S3020 in FIG. 3.

When service server 100 determines that the reserved parking space requester can be arrived at the target parking space (Yes—S8080), service server 100 may continuously monitor the target parking space at step S8130. At step S8140, service server 100 may determine whether a vehicle is detected at the target parking space based on the monitoring information.

When a vehicle is detected (Yes—S8140), service server 100 may determine whether the detected vehicle is the reserved vehicle at step S8150. When the detected vehicle is the reserved vehicle (Yes—S8150), service server 100 may perform operation similar to the operation (B) shown in FIG. 5. When the detected vehicle is not the reserved vehicle (No—S8150), service server 100 may transmit a warning message to the detected vehicle and request the detected vehicle to leave the target parking space at step S4040 in FIG. 4.

When the detected vehicle is not the reserved vehicle (No—S8140), service server 100 may determine whether a reserved rental period is passed at step S8160. When the reserved rental period is not passed (No—S8160), service server 100 may continuously monitor the reserved parking space at step S8130. When the reserved rental period is passed (Yes—S8160), service server 100 may cancel the reservation at step S8170 and update the associated parking space information at step S8120.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of renting a parking space with others, the method comprising:
monitoring a target parking space through controlling monitoring devices installed around a target parking space based on target parking space information;
detecting a vehicle in the target parking space based on the monitoring result; and
performing a first parking space renting operation for renting the target parking space to the detected vehicle through user equipment associated with the detected vehicle.

2. The method of claim 1, wherein the monitoring includes:
determining the target parking space based on the target parking space information included in registration information of a parking space owner of the target parking space;
controlling at least one monitoring device installed around the target parking space to monitor the target parking space; and
receiving the monitoring information from the at least one monitoring device.

3. The method of claim 1, wherein the monitoring devices includes a sensor configured to detect an object located in the target parking space, a signal detector configured to detect a signal transmitted from a vehicle, and an image capturing device configured to capture images of the target parking space.

4. The method of claim 1, wherein the detecting includes:
analyzing signals detected by and images of the target parking space captured by at least one of monitoring devices; and
determining whether a vehicle is located in the target parking space based on the analysis result.

5. The method of claim 1, wherein the first parking space renting operation includes:
transmitting an inquiry message to user equipment associated with the detected vehicle for asking whether to rent the target parking space;
determining whether the detected vehicle wants to rent the target parking space at an associated rental condition based on a response message received in response to the inquiry message;
performing an accounting procedure for charging a rental fee of the target parking space to the detected vehicle when the detected vehicle wants to rent the target parking space;
updating the target parking space information based on the associated rental condition including a rental period; and
monitoring the target parking space based on the updated target parking space information.

6. The method of claim 5, wherein the first parking space renting operation includes:
transmitting a request message to user equipment associated with the detected vehicle for asking to leave the target parking; and
transmitting a towing request message to an associated towing station to tow the detected vehicle from the target parking space when the detected vehicle is detected again in the target parking space after transmitting the request message.

7. The method of claim 1, wherein the performing a first parking space renting operation includes:
determining whether a detected vehicle is an authorized vehicle based on registration information of a parking space owner upon detection of a vehicle;
performing the first parking space renting operation when the detected vehicle is an unauthorized vehicle;
otherwise, monitoring the target parking space without performing the parking space renting operation.

8. The method of claim 1, wherein the performing a first parking space renting operation includes:
determining whether a detection time is in a scheduled time for renting the target parking space when a vehicle is detected in the target parking space;
performing the first parking space renting operation when the detection time is in the scheduled time;
otherwise, performing a second parking space renting operation,
wherein the scheduled time is a desired time for renting a target parking space, which is set by an associated parking space owner.

9. The method of claim 8, wherein the second parking space renting operation includes:
transmitting an inquiry message to user equipment of the associated parking space owner whether to rent the target parking space to the detected vehicle when the detection time is not in the scheduled time;
determining whether the associated parking space owner wants to rent the target parking space by a response message received in response to the inquiry message;
performing the first parking space renting operation when the associated parking space owner wants to rent the target parking space.

10. The method of claim 8, wherein the second parking space renting operation includes:
transmitting a request message to user equipment associated with the detected vehicle for asking to leave the target parking space; and
transmitting a towing request message to an associated towing station to tow the detected vehicle from the target parking space when the detected vehicle is detected again in the target parking space after transmitting the request message.

11. The method of claim 1, comprising:
monitoring the target parking space after performing the first parking space renting operation based on target parking space information updated based on the first parking space renting operation;
transmitting an inquiry message to user equipment associated with the detected vehicle for asking whether to extend a rental period;
performing an accounting procedure for charging a extension fee of the target parking space to the detected vehicle when the detected vehicle wants to extend the rental period of the target parking space;
updating the target parking space information based on the extended rental period; and
monitoring the target parking space based on the updated target parking space information.

12. The method of claim 11, comprising:
transmitting a request message to user equipment associated with the detected vehicle for asking to leave the target parking when the detected vehicle request no extension of the rental period; and
transmitting a towing request message to an associated towing station to tow the detected vehicle from the target parking space when the detected vehicle is detected again in the target parking space after transmitting the request message.

13. The method of claim 1, comprising:
receiving a registration request from a parking space owner;
obtaining target parking space information, owner information, and desired rental condition information from the parking space owner;
storing and managing the target parking space information, the owner information, and the desired rental condition information as the registration information of the associated parking space owner; and
monitoring the target parking space of the associated parking space owner based on the stored registration information of the associated parking space owner.

14. The method of claim 1, comprising;
receiving a registration request from a parking space requester;
obtaining vehicle information and driving information of the parking space requester; and
storing and managing the vehicle information and the driving information in connection with the associated parking space requester.

15. A method of renting a parking space with others, the method comprising:
providing an available parking space list to user equipment associated with a parking space requester in response to a request from the parking space requester;
receiving a parking space renting request with a selected parking space from the parking space requester through the associated user equipment;
performing a parking space renting operation for renting the selected parking space to the parking space requester.

16. The method of claim 15, comprising:
receiving a reservation request with a selected parking space and a desired rental time from the parking space requester;
performing a reservation operation of the selected parking space based on the desired rental time as a reserved rental time;
updating target parking space information of the selected parking space based on the result of the reservation operation; and
monitoring the selected parking space based on the updated target parking space information.

17. The method of claim 16, comprising:
transmitting an inquiry message to user equipment associated with the parking space requester at a predetermined time before the reserved rental time for asking whether to keep the reservation of the selected parking space;
updating the target parking space information of the selected parking space based on a response message received in response to the inquiry message; and
monitoring the target parking space based on the updated target parking space information.

18. The method of claim 17, wherein the transmitting the inquiry message includes:
determining a location of the parking space requester at a predetermined time before the reserved rental time;
estimating an arrival time of the parking space requester at the selected parking space; and
transmitting the inquiry message when the estimated arrival time is later than the reserved rental time.

19. The method of claim 16, wherein the receiving a reservation request includes:
determining whether more than two reservation request messages are received for reserving a first parking space with a same desired rental period from parking space requesters;
performing an auction procedure for selecting one of the parking space requesters to rent the first parking space;
otherwise, performing a reservation operation of the selected parking space based on the desired rental time as a reserved rental time.

20. The method of claim 19, wherein the performing an auction procedure includes:
receiving an auction condition from an associated parking space owner;
selecting one offering a higher bid from the parking space requesters by performing the auction procedure based on the received auction condition; and
performing the parking space renting procedure to rent the target parking space to the selected one.
